(19) United States
(12) Patent Application Publication
(10) Pub. No.: US 2022/0076233 A1
(43) Pub. Date: Mar. 10, 2022

(54) TOUCHLESS PAYMENT PROCESSING METHODS AND SYSTEMS

(71) Applicant: PruPay, LLC, Golden, CO (US)

(72) Inventors: William Sedgwick, Newport, OR (US); John Carpenter, Golden, CO (US); Craig Fox, Seaside, CA (US); Jeffrey Little, Glendale, AZ (US); Viktor Falendysh, Phoenix, AZ (US)

(21) Appl. No.: 17/526,679

(22) Filed: Nov. 15, 2021

Related U.S. Application Data
(63) Continuation of application No. PCT/US2021/032034, filed on May 12, 2021.
(60) Provisional application No. 63/023,700, filed on May 12, 2020.

(51) Int. Cl. G06Q 20/32; G06Q 20/40; G06Q 20/38

(52) U.S. Cl. CPC G06Q 20/3255; G06Q 20/382; G06Q 20/409

(57) ABSTRACT

Methods, systems and devices directed to touchless payment processing are described. An example embodiment relates to a system that can coordinate an order request and payment processing between a vendor and client. The system can allow for a vendor to prepare an order request for a client that includes a client identifier (e.g., a mobile phone number). The system can then allow for the client device to efficiently provide payment information via a third-party payment processor. Other example embodiments can allow for efficient and contactless (or “touchless”) payment processing for goods/services by a vendor. Furthermore, the described systems can limit access to specific information (e.g., payment data, client data) to only authorized individuals associated with the vendor, which can mitigate/prevent unauthorized access to various information included in a vendor interface.

### CROSS-REFERENCE TO RELATED APPLICATION

This patent document claims priority to and benefits of U.S. Provisional Patent Application No. 63/023,700 and filed on May 12, 2020. The entire content of this patent application is incorporated by reference as part of the disclosure of this patent document.

### TECHNICAL FIELD

This document generally relates to touchless payment systems.

### BACKGROUND

In many instances, entities (e.g., vendors, retailers) provide goods/services to clients. As an example, a restaurant can provide various food items to clients. In these instances, the client can purchase goods/services from an entity using a purchasing process.

This can include providing information describing the requested goods/services, and the entity can provide a value in providing the services and the client can provide a payment method (e.g., cash, credit card number). A payment processing service associated with the entity can process the payment on behalf of the entity and the goods/services can be provided to the client.

In many cases, entities and clients may prioritize speed and efficiency in placing an order for goods/services. One straightforward method for providing payment information for goods/services can include providing cash or a credit card to the entity.

### SUMMARY

Embodiments of the described technology provide technical solutions for touchless payment processing, which advantageously results in secure and efficient transactions that reduce the risk of spreading a contagion and mitigates the effect of malicious eavesdroppers. The disclosed embodiments can, for example, be used in a variety of retail infrastructures.

In an example aspect, a method of using a touchless payment processing system is disclosed. The method includes transmitting, to a client, a message comprising a link to an interface configured to accept payment information from the client, wherein the message is transmitted in response to the client contacting a vendor with an order for one or more goods or services from the vendor, receiving, from the client via the interface, the payment information, processing, using the payment information, a payment corresponding to the order for the one or more goods or services, and transmitting, subsequent to a completion of the processing of the payment, a confirmation of the payment to the client and the vendor.

In another example aspect, a system for touchless payment processing is disclosed. The system includes a processing system, a client device communicatively coupled to the processing system, and a vendor device communicatively coupled to the processing system and the client device, wherein the vendor device is configured to receive an order request for one or more goods or services, wherein the processing system is configured to detect a client identifier from the order request, and transmit, using the client identifier, a message comprising a link to the client device, wherein the client device is configured to present, responsive to a client selecting the link, a user interface to a client, wherein the processing system is further configured to receive, from the user interface, payment information, transmit, to a third-party server, the payment information, and provide, responsive to detecting that a payment processing for the order request based on payment information was successful, a confirmation indication to the client device and the vendor device.

In yet another exemplary aspect, the above-described methods are embodied in the form of processor-executable code and stored in a computer-readable program medium.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

Various features of the technology will become more apparent to those skilled in the art from a study of the Detailed Description in conjunction with the drawings. Embodiments of the technology are illustrated by way of example and not limitation in the drawings, in which like references may indicate similar elements.

FIG. 1 illustrates an example environment in which the present embodiments can be implemented.

FIG. 2 is an illustration of an example interface for onboarding a new individual to a vendor.

FIG. 3 is an illustration of an example vendor interface.

FIG. 4 is an illustration of an example client interface.

FIGS. 5A and 5B are flowcharts for example methods for implementing touchless payment processing.

FIG. 6 illustrates an example payment settings interface.

FIG. 7 illustrates an example administrator dashboard.

FIG. 8A illustrates example registration interfaces.

FIG. 8B illustrates an example payment history interface.

FIG. 8C illustrates an example settings modification interface.

FIG. 8D illustrates an example payment history interface.

FIG. 8E illustrates an example payment settings interface.

FIG. 8F illustrates example new payment request interfaces.

FIG. 8G illustrates example client confirmation interfaces.

FIG. 8H illustrates example vendor confirmation interfaces.

FIG. 9 is a block diagram illustrating an example of a processing system in which at least some operations described herein can be implemented.

The drawings depict various embodiments for the purpose of illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

In many instances, an order for goods/services can include an exchange of information and physical items (e.g., cash, credit card) between a vendor and client. For example, the client (or “customer”) can contact a restaurant to order food items and provide a credit card to pay for the food items.

However, such a method includes handling/exchanging physical items between parties. This can increase a risk of spreading a contagious material, such as a virus, illness, etc. Accordingly, techniques to efficiently provide information to pay for goods/services while limiting exchange of materials between parties may be desired.

One such method to provide an order while limiting exchange of physical items between parties can include a verbal or telephonic order request by the client. Particularly, a client can provide various information (e.g., requested goods/services, a name of the client, a credit card number) to a vendor. Upon receipt of the information, the vendor can input the information, prepare the order, and process payment given the vendor payment information.

However, verbally providing information to a vendor can be inefficient and leave client data vulnerable to unauthorized access. For instance, the vendor may incorrectly enter client information, which may result in inefficient processing of an order. As another example, an employee of a vendor may maliciously record sensitive information of the client and perform an unauthorized action using the sensitive information (e.g., make an unauthorized purchase, sell the information). Further, as another example, a third-party entity may overhear or otherwise obtain the sensitive information of the client and perform an unauthorized action using the sensitive information.

### Example System Overview

The present embodiments relate to a touchless payment processing system. Particularly, the present embodiments relate to a system that can coordinate an order request and payment processing between a vendor and client. The system can allow for a vendor to prepare an order request for a client that includes a client identifier (e.g., a mobile phone number). The system can then allow for the client device to efficiently provide payment information via a third-party payment processor.

The present embodiments can allow for efficient and contactless (or “touchless”) payment processing for goods/services by a vendor. Further, the present system can limit access to specific information (e.g., payment data, client data) to only authorized individuals associated with the vendor. This can mitigate/prevent unauthorized access to various information included in a vendor interface.

As an illustrative example, the client, via a client device, can contact a vendor to order a specific set of goods/services. This can include a phone call to a phone of the vendor, for example. During this interaction, the client can provide the requested goods/services, a name of the client, and/or a phone number of the client.

In response to obtaining the request for the goods/services, the vendor, via an application/webpage executing on a vendor device, can input a new order request. The new order request can include a cost for the goods/services, a description of the goods/services to be provided to the client, and the client information (e.g., a phone number of the client).

The client device can then receive a message (e.g., a text message, short message service (SMS) message) from the system. The message can include a link to a webpage/application provided by the present system.

Responsive to selecting the link on the client device, the client device can provide a payment confirmation webpage that can allow for the client to provide payment information. For instance, the client can provide credit card information on the webpage or select one of a series of smart buttons directing the client to provide third-party payment information. In the webpage, the client can specify other information, such as a delivery address, an additional tip, a charitable contribution, etc. Upon receipt of payment information from the client, the system can process the payment and confirm payment to the vendor and client. Responsive to processing the payment information, the vendor application can indicate that payment is successful, and the goods/services can be provided to the client.

The vendor may add transactional components to the sub-total transaction in advance of sending the information to the customer (e.g., a convenience fee and/or a delivery fee). The customer may add transactional components (e.g., a tip or a separate additional amount) to the total in advance of sending the total amount to the processor.

### Example Environment Overview

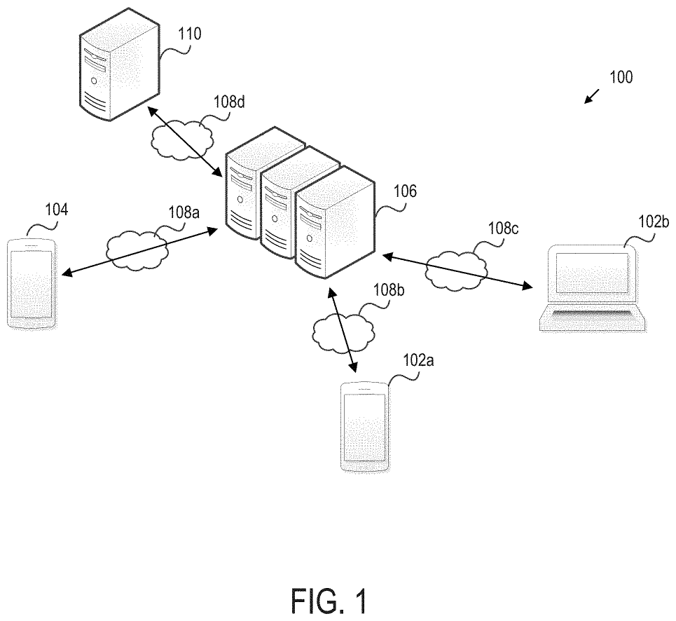

FIG. 1 illustrates an example environment 100 in which the present embodiments can be implemented. The environment 100 can include one or more vendor devices 102a-b. Each vendor device 102a, 102b can include a network-accessible device (e.g., a smartphone, tablet, computer) capable of presenting a vendor interface to a client. The vendor interface can include a webpage/application provided by network-accessible server system 106 that is specific to the vendor.

As described in greater detail below, the vendor interface can allow for an individual (e.g., an employee of the vendor) to input an order for a client, view an order status, etc. An operator can provide credentials (e.g., a passcode, biometric information) to log onto the vendor interface on vendor device 102a, 102b.

The vendor can include a plurality of individuals (e.g., employees) associated with the vendor. Each individual can include any of various levels of authorization in the vendor interface. Each level of authorization can allow an operator to access more information on the vendor interface.

As an example, multiple levels of authorization can be available. A first level of authorization can allow for an individual to add a new order and view a status of the order. A second level of authorization can allow for an individual to view more detailed information, such as a total number of orders for a time period, detailed client information, etc. A third level of authorization can allow access for an individual to view detailed information relating to all orders for the vendor, analytics, etc. The varying levels of authorization can limit access to specific data that is sensitive information only to authorized individuals.

The environment can include a client device 104. The client device 104 can include a network-accessible device associated with a client. The client device 104 can include an identifier (e.g., phone number, IP address) that can be used to provide a payment link to the individual device 104. For instance, the individual device 104 can contact a vendor device 102a-b or another device to order goods/services. In turn, the system 106 can provide a message that includes a link to a client interface. As noted above, the client interface can allow for the client to provide payment information, delivery information, etc., to confirm an order of goods/services.

The environment 100 can include a network-accessible server system 106. The network-accessible server system 106 can include one or more computing devices (e.g., servers) capable of storing information and performing processing tasks as described herein.

The devices included in the environment 100 can communicate via networks 108a-d. The network(s) 108a-d can include personal area networks (PANs), local area networks (LANs), wide area networks (WANs), metropolitan area networks (MANs), cellular networks, the Internet, etc. Additionally or alternatively, the network-accessible server system 106 can be communicatively coupled to devices device(s) in the environment 100 over a suitable wired/wireless communication protocol.

The network-accessible server system 106 can communicate with a third-party server 110. The third-party server 110 can include a device associated with a third party (e.g., a payment processor). The network-accessible server system 106 can connect with third-party server 110 via an application programming interface (API), a plugin, etc. The network-accessible server system 106 and third-party server 110 can securely communicate via a suitable encryption technique (e.g., 128-bit or 256-bit AES). For example, the network-accessible server system 106 can securely provide payment information to the third-party server 110 for processing by the third-party server 110.

### Example Vendor Onboarding Overview

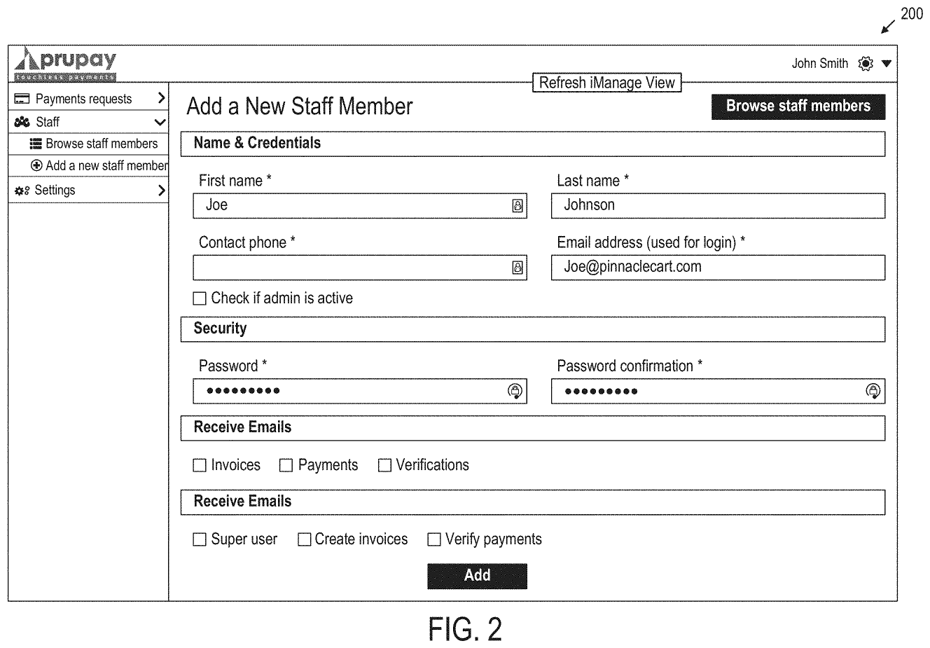

FIG. 2 is an illustration of an example interface 200 for onboarding a new individual to a vendor. The interface 200 can allow for a new individual account to be added to the system. For instance, only accounts with a specific authorization level can add new members to the system. The new account interface 200 can allow for individual information to be entered into the system as well as an authorization level of the individual. For example, the interface can allow for credentials to be provided for the individual, such as a name, email address, phone number, etc.

In some embodiments, an authorization level of the individual can be identified. The authorization level can be indicative of an amount of data that the individual can access. For example, a permission can be a super user (e.g., access to all data), the individual can create invoices, the individual can verify payments, etc.

### Example Vendor Interface Overview

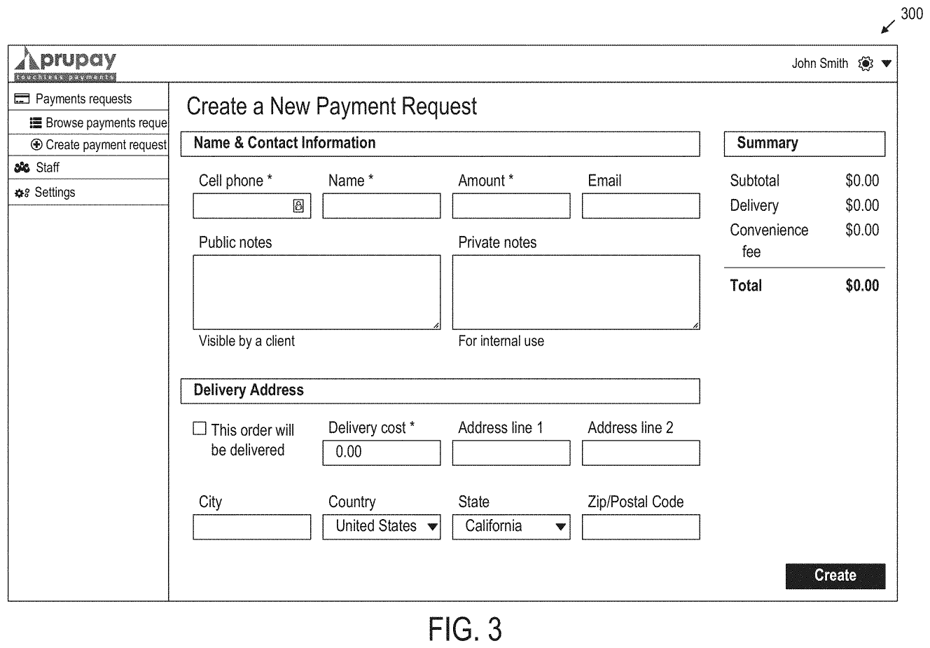

FIG. 3 is an illustration of an example vendor interface 300. As noted above, the vendor interface 300 can be executed on a vendor device (e.g., vendor device 102a-b). The vendor device can be modified based on an authorization level of the individual logged into the vendor device.

The vendor interface 300 can include a login button. The login button can allow for a user to log into the vendor interface or log out of the vendor interface. For example, the individual can provide a passcode, biometric information, etc., to retrieve a vendor interface 300 that corresponds to the individual and their associated authorization level.

The vendor interface 300 can include multiple fields to allow for a new order to be entered for the client. For example, if the client requests that a set of food items be delivered to the client, fields of the vendor interface 300 can specify the aspects of the order. In some embodiments, information specific to the vendor (e.g., additional fees, vendor-specific food items) can be added to the fields of the vendor interface 300. As an example, the fields of the vendor interface 300 can specify a name, phone number, email address of the client, a description of the goods/services to the client, etc. The fields can also include notes that are private (e.g., only known to certain individuals of a specific authorization level) and public notes (e.g., information that can be shared between individuals of all authorization levels).

In some embodiments, a vendor can have multiple retail locations (e.g., a restaurant with multiple locations). In these embodiments, individuals with lower authorization levels (e.g., a first authorization level) may only access order information for a first location of the vendor.

In some embodiments, the vendor can be associated with a number of entities (e.g., vendors at a market). In these embodiments, the vendor interface 200 can be common to multiple entities and an order can be divided among multiple entities based on a number of items ordered/purchased.

In some embodiments, the vendor device can detect client information upon receipt of a message (e.g., phone call) from the client. For example, the vendor device can include a phone that can identify a phone number of the client device. In these embodiments, the system can identify a corresponding client account and populate information for the client maintained by a network-accessible server system.

### Example Client Interface Overview

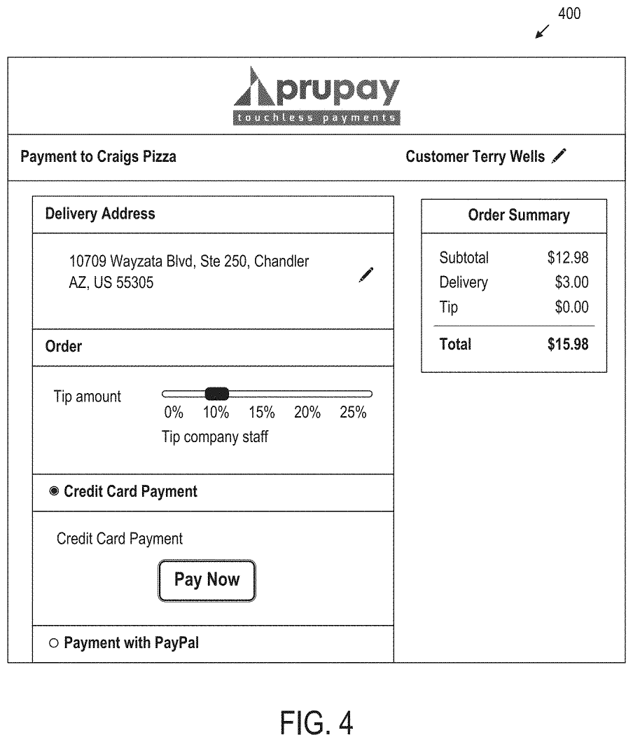

FIG. 4 is an illustration of an example client interface 400. The client interface 400 can be provided to the client device via a message (e.g., text message). For instance, upon selecting the link, the client device can retrieve the client interface 400. The client interface 400 can include an application executing on the client device or a webpage, for example.

In some embodiments, the client interface 400 can include multiple additional fields (or “enhancements”) that allows for a client to complete an order and provide payment information. For example, the fields can include a delivery address, a tip amount (e.g., via a slider), a convenience charge, a charitable donation option, a “Pay It Forward” to the vendor option, which is an additional payment to the vendor that is not a tip or payment for products or services, credit card information input fields, etc. Each of these fields can be turned on or off by the vendor, depending on the vendor's choice of which field to include (payment options are customizable.) Vendors can allow customers to decline convenience charges. Convenience charges can be made to be a percentage of the sub-total, or a flat fee. Convenience charges, “Pay It Forward”, and donations can be described in a separate field by the merchant indicated by a question mark (?) on the appropriate section of the payment request.

The client interface 400 can include multiple fields that allows for a client to complete an order and provide payment information. For example, the fields can include a delivery address, a tip amount (e.g., via a slider), a charitable donation option, credit card information input fields, etc.

In some embodiments, the client interface 400 can allow for recommended items or previously-purchased items to be displayed on the client interface 400. For example, the system can utilize prior purchase data to identify recommended items/services for the client.

In some embodiments, the client account can be stored by the system. The client account information can be used to prepopulate the client interface when logged into by the client.

The client interface 400 can include smart buttons that indicate various third-party payment processors that can efficiently process the payment. Upon selection of a smart button, the system can provide information to a third-party server to perform payment processing at the third-party server.

### Examples of Touchless Payment Processing Methods

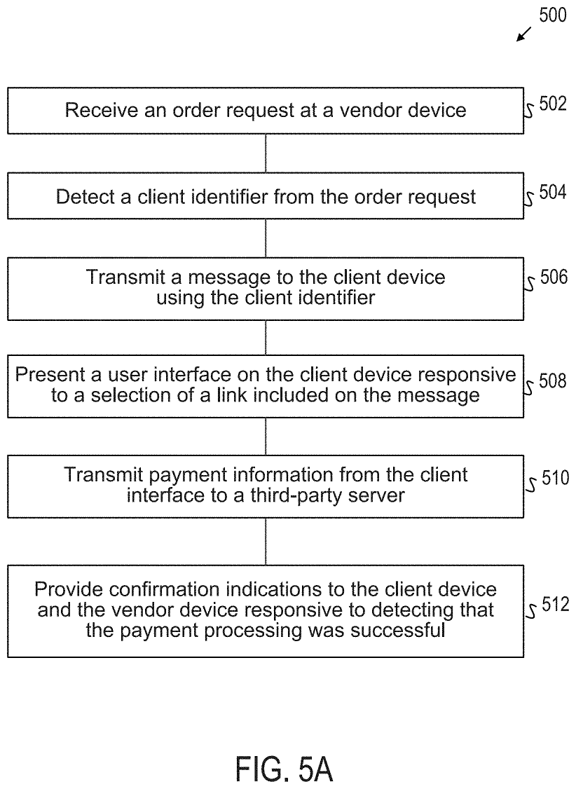

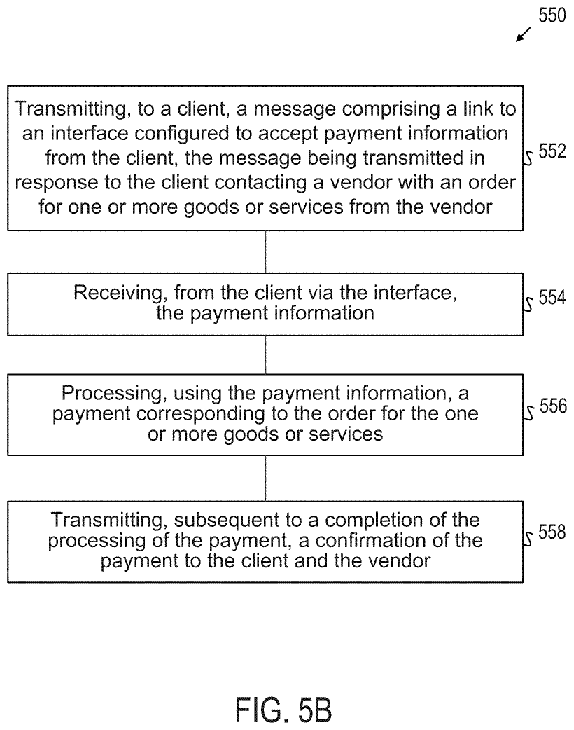

FIG. 5A is a flowchart of an example method 500 for implementing a touchless payment processing process. The method includes, at operation 502, receiving an order request at a vendor device. In some embodiments, the order request can include a message (e.g., phone call, voice communication, email, text) received by a vendor device (e.g., phone, tablet, computer). In other embodiments, the order request can include an indication of client information and requested goods/services. In some embodiments, the order request can include an individual inputting order request information into a vendor interface.

The method includes, at operation 504, detecting a client identifier from the order request. In some embodiments, the client identifier can include information indicative of a client device, such as a phone number, email address, internet protocol (IP) address, etc.

The method includes, at operation 506, transmitting a message to the client device using the client identifier. In some embodiments, the message can include a text message that includes a link to access a client interface to be displayed on the client device.

The method includes, at operation 508, presenting a user interface on the client device responsive to a selection of a link included on the message. In some embodiments, the client interface can allow for the client to provide various information, such as payment information, delivery information, etc.

The method includes, at operation 510, transmitting payment information from the client interface to a third-party server. In some embodiments, the payment information can be processed by a third-party service (e.g., an external payment processor). In other embodiments, the system can internally perform payment processing. The third-party service can include one of a plurality of potential payment processors connected to the present system.

The method includes, at operation 512, providing confirmation indications to the client device and the vendor device responsive to detecting that the payment processing was successful. In some embodiments, the confirmation indications can indicate that payment was successful and can be used by the vendor to provide the goods/services to the client.

FIG. 5B is a flowchart of another example method 550 for implementing a touchless payment processing process. The method includes, at operation 552, transmitting, to a client, a message comprising a link to an interface configured to accept payment information from the client, the message being transmitted in response to the client contacting a vendor with an order for one or more goods or services from the vendor. In some embodiments, ordering the one or more goods or services corresponds to a first one-time transaction between the client and the vendor. In other embodiments, the interface is configured to enable the client to input at least one of a gratuity amount, a convenience fee, delivery information, or an expiration time associated with the order.

The method includes, at operation 554, receiving, from the client via the interface, the payment information.

The method includes, at operation 556, processing, using the payment information, a payment corresponding to the order for the one or more goods or services. In some embodiments, processing the payment comprises transmitting, to a third-party payment processor, the payment information and details associated with the order for the one or more goods or services, and receiving, from the third-party payment processor, the confirmation of the payment. In an example, communication with the third-party payment processor is performed using an application programming interface (API) and an encryption method.

The method includes, at operation 558, transmitting, subsequent to a completion of the processing of the payment, a confirmation of the payment to the client and the vendor.

In some embodiments, the method 550 further includes the operation of transmitting the confirmation of the payment to a delivery person or service provider associated with delivering or performing the one or more goods or services, respectively, wherein the one or more goods or services are provided to the client subsequent to the transmitting the confirmation.

In some embodiments, an operator of a vendor device is provided with a first authorization level and the delivery person or service provider is provided with a second authorization level. Herein, an authorization level is indicative of an amount of data that can be access by a person with the authorization level, and the first authorization level provide the operator access to more than the second authorization level provides to the delivery person or service provider.

In some embodiments, the method 550 further includes the operation of identifying, prior to transmitting the message, the client based on a client identifier. In an example, the client identifier comprises one or more of a phone number associated with a client device of the client, an Internet Protocol (IP) address or a media access control (MAC) address associated with the client device, or an email address of the client.

In some embodiments, the method 550 further includes the operations of transmitting, to the vendor, onboarding information, and receiving, from the vendor in response to transmitting the onboarding information, information associated with one or more employees of the vendor and the one or more goods or services.

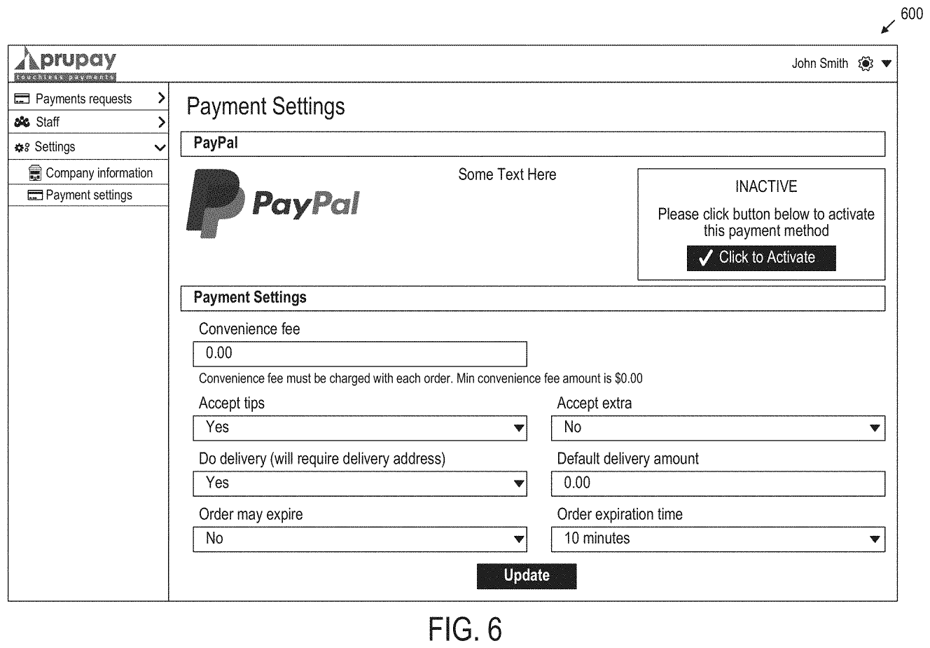

FIG. 6 illustrates an example payment settings interface 600. The payment settings interface 600 can include fields that the vendor can modify to update settings for order requests provided on the vendor interface. For example, the payment settings interface 600 can allow for modifying a convenience fee, accept tips, accept extra money, delivery, default delivery amount, order expiration, etc.

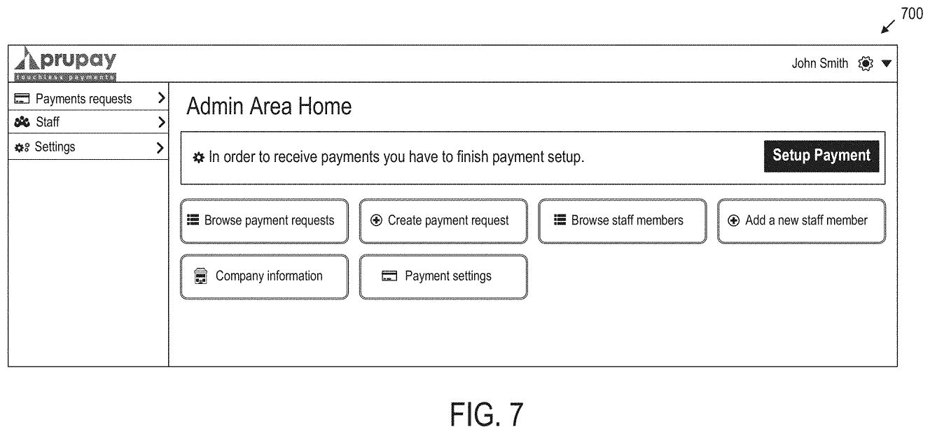

FIG. 7 illustrates an example administrator dashboard 700. The administrator dashboard 700 can include a dashboard that allows for an authorized user to view various information relating to the vendor. For instance, only super users or those with a third authorization level can only access the administrator dashboard 700. For example, the administrator dashboard 700 can allow for a user to view payment requests, staff members, add new staff members, view analytics, etc.

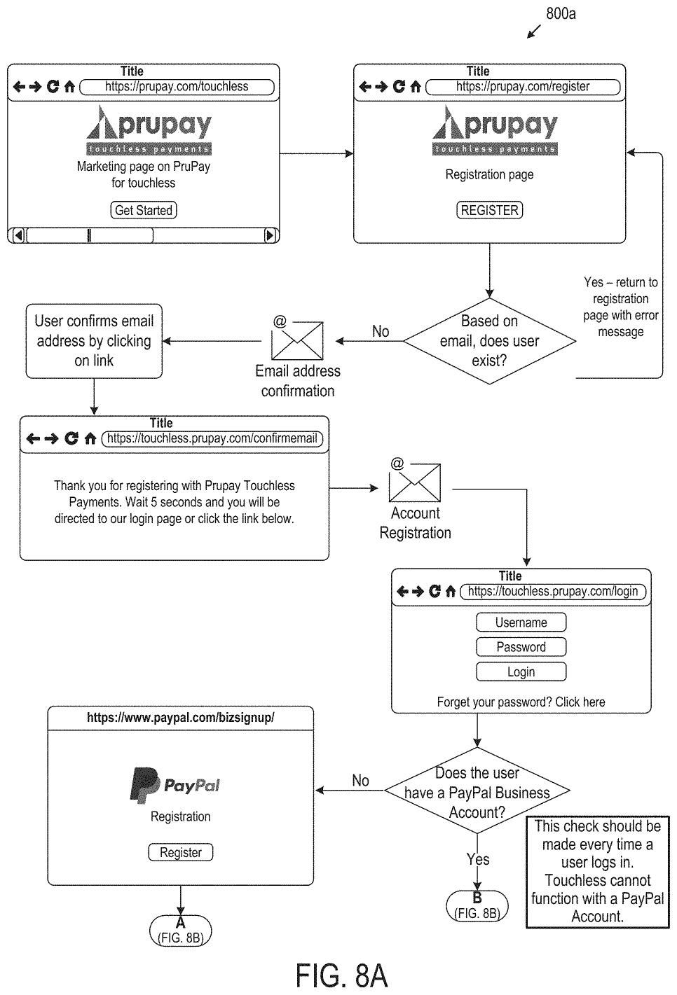

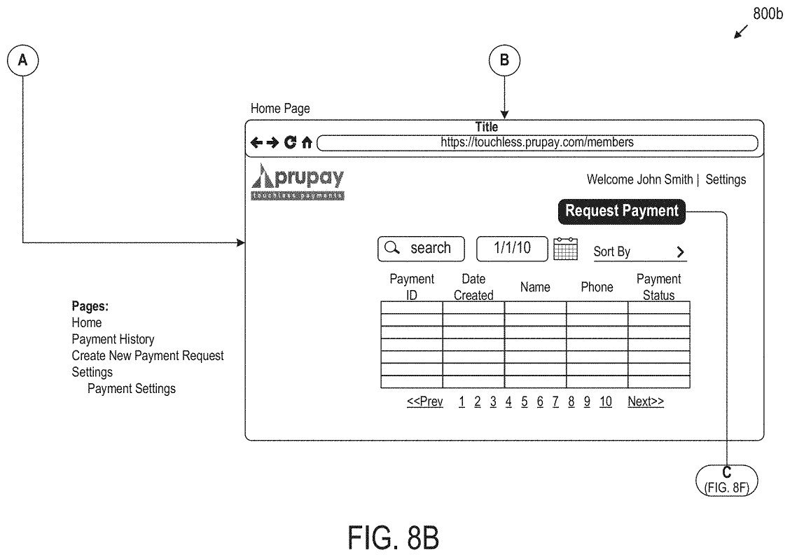

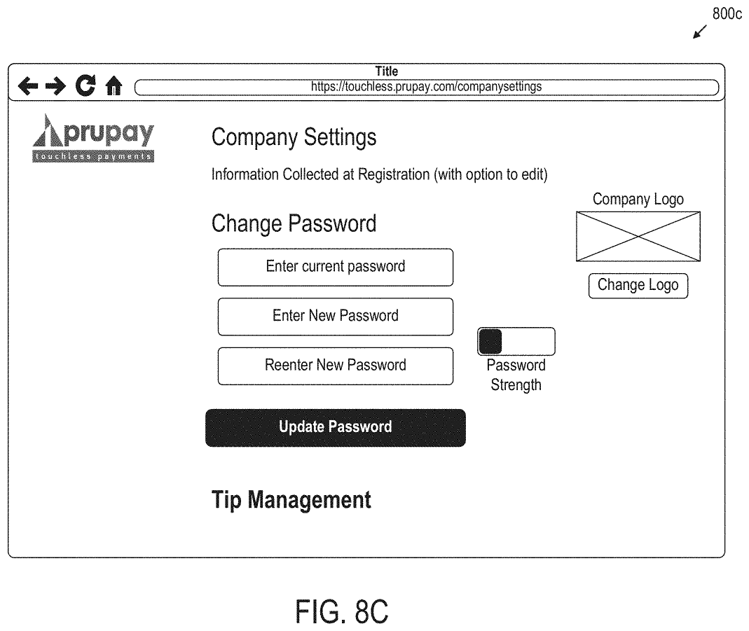

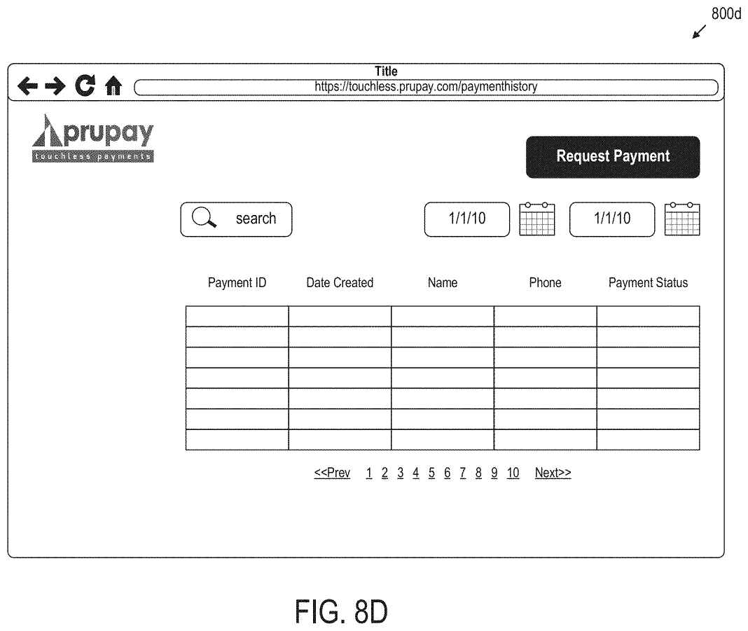

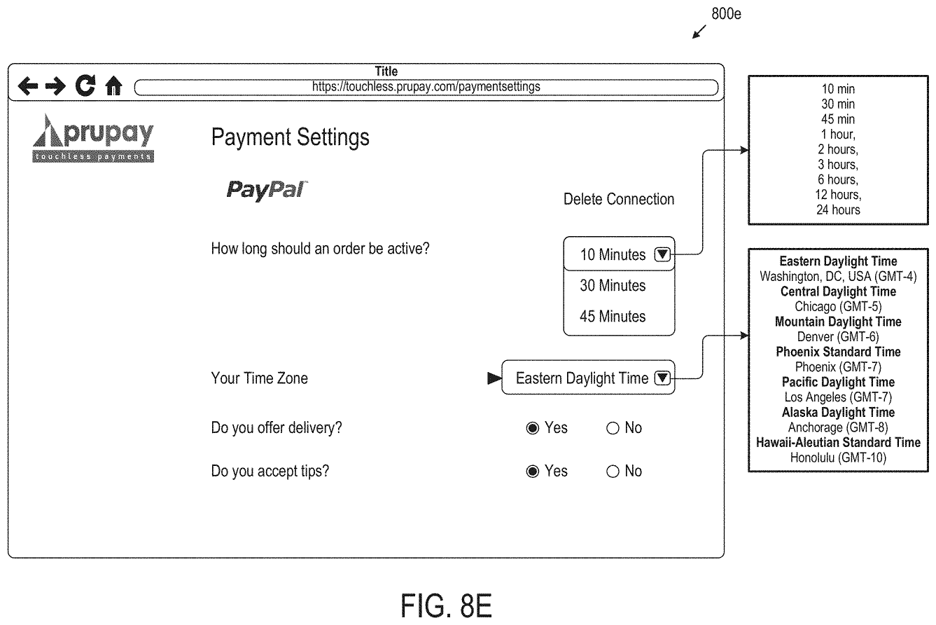

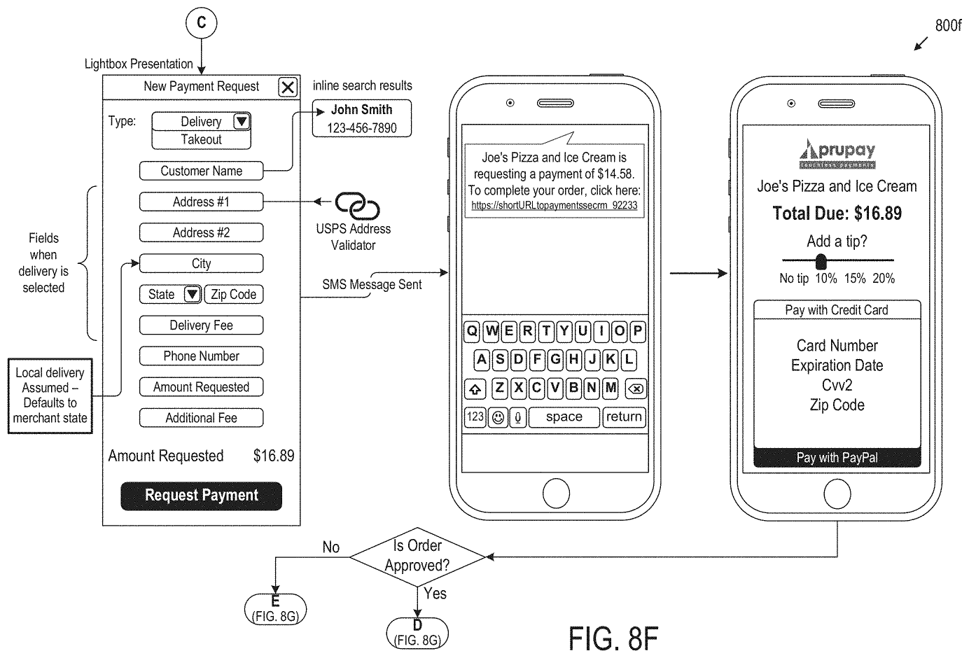

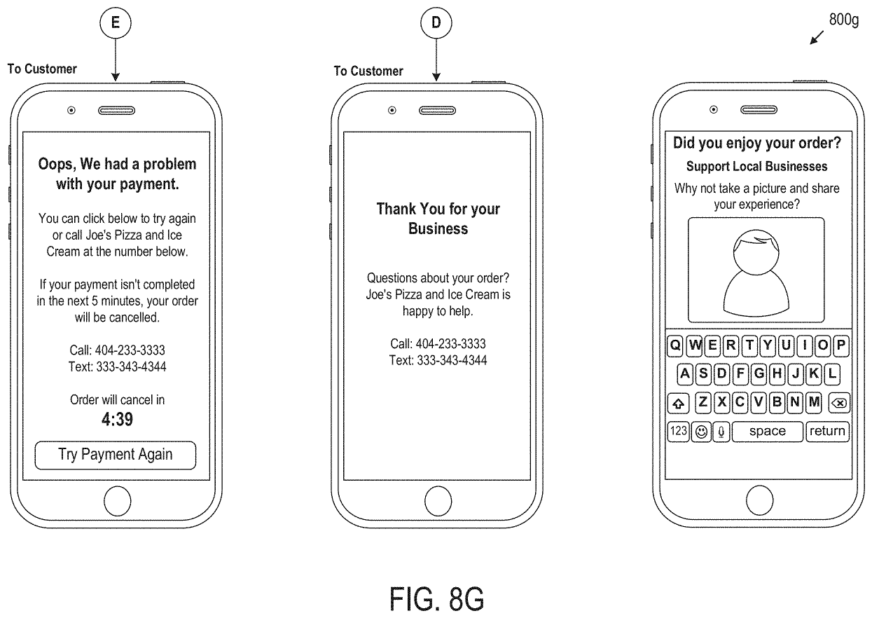

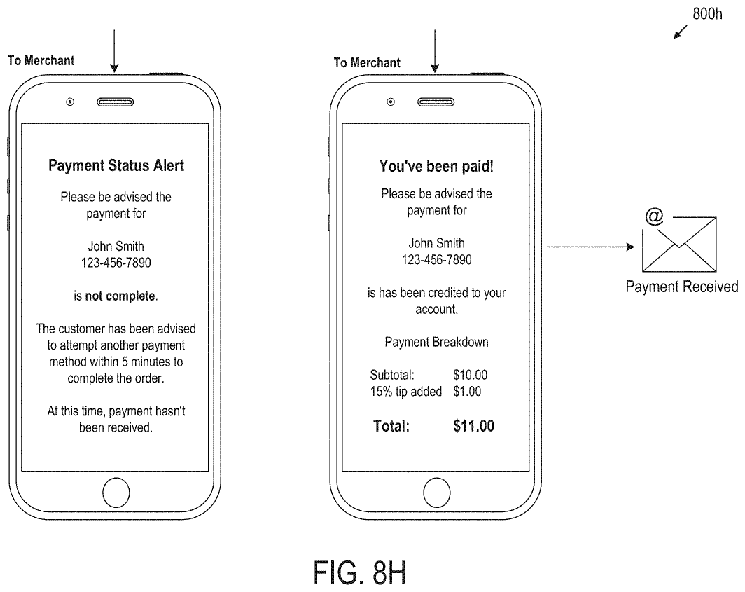

FIGS. 8A-8H includes various block diagrams illustrating an example user journey. FIG. 8A illustrates example registration interfaces 800a. For example, a user (e.g., a vendor, client) can provide contact information and register with a third-party service (e.g., a payment processor).

FIG. 8B illustrates an example payment history interface 800b. The payment history interface 800b can include a listing/table illustrating a number of orders created by a vendor. The payment history interface 800b can include a payment identifier, a date created, name of the client, phone number, payment status, etc.

In some embodiments, the payment history interface 800b can include a breakdown of the payment types, such as an order payment, a tip amount, a charitable contribution, a support payment to the vendor, etc. The various payment types can be utilized in performing tasks such as distributing funds among employees of the vendor, provide a charitable donation to a charity, support a vendor or another organization of the client's choosing, etc.

FIG. 8C illustrates an example settings modification interface 800c. The settings modification interface 800c can allow for an authorized user to change settings, such as a vendor name, vendor logo, password, etc.

FIG. 8D illustrates an example payment history interface 800d. FIG. 8E illustrates an example payment settings interface 800d. The payment settings interface 800d can include an interface that allows for a vendor to modify payment settings, such as a connection to a payment processor, a time that the order is active, a time zone, delivery information, tip information, etc.

FIG. 8F illustrates an example of the new payment request interfaces 800f. The new payment request interfaces 800f can include, for example, a vendor interface providing a new payment request to detail an order provided by the client, a text message provided to the client device, and a client interface allowing for the client to provide payment information to be processed by the system. In some embodiments, the payment processing can be performed either by a third-party payment processor or internally by the network-accessible server system.

FIG. 8G illustrates example client confirmation interfaces 800g. For example, an interface can indicate that if payment was unsuccessful, a request to provide payment information again can be sent to the client device. As another example, the client can obtain an indicator that payment was successful if payment was successful. In some instances, the client interface can request feedback from the client regarding their experience interacting with the client interface.

FIG. 8H illustrates example vendor confirmation interfaces 800h. The vendor confirmation interfaces 800h can include indications that the client has successfully paid for an order. The indications can be used to update a payment dashboard for the vendor to indicate that client payment has successfully processed and the goods/services can be provided to the client. In some instances, the types of payment (e.g., payment for order, tip, charitable donation, vendor support donation) can be viewable by authorized users.

### Processing System

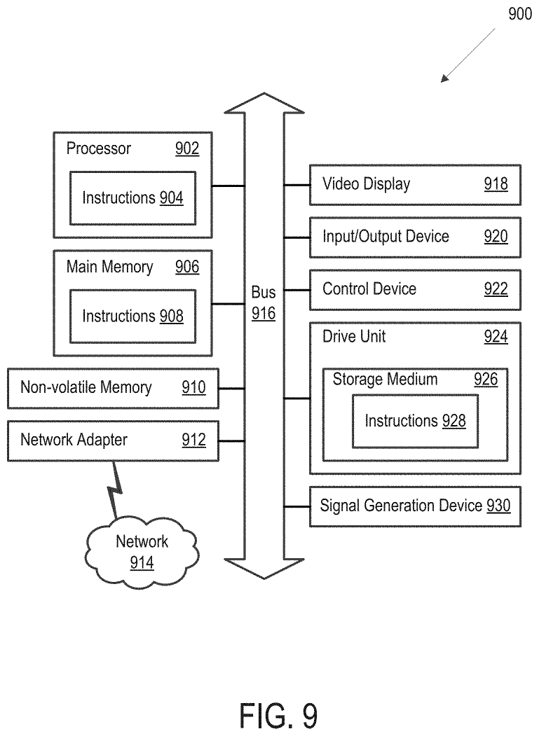

FIG. 9 is a block diagram illustrating an example of a processing system 900 in which at least some operations described herein can be implemented. For example, some components of the processing system 900 may be hosted on an electronic device that includes a session management platform (e.g., session management platform 92 of FIG. 1). As another example, some components of the processing system 900 may be hosted on an electronic device configured to generate digital media.

The processing system 900 may include one or more central processing units (“processors”) 902, main memory 91006, non-volatile memory 910, network adapter 912 (e.g., network interface), video display 918, input/output devices 920, control device 922 (e.g., keyboard and pointing devices), drive unit 924 including a storage medium 926, and signal generation device 930 that are communicatively connected to a bus 916. The bus 916 is illustrated as an abstraction that represents one or more physical buses and/or point-to-point connections that are connected by appropriate bridges, adapters, or controllers. The bus 916, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The processing system 900 may share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 900.

While the main memory 906, non-volatile memory 910, and storage medium 926 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 928. The term “machine-readable medium” and “storage medium” shall also be taken to include any medium that is capable of storing, encoding, or carrying a set of instructions for execution by the processing system 900.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in a computing device. When read and executed by the one or more processors 902, the instruction(s) cause the processing system 900 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory devices 910, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 912 enables the processing system 900 to mediate data in a network 914 with an entity that is external to the processing system 900 through any communication protocol supported by the processing system 900 and the external entity. The network adapter 912 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 912 may include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to describe the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

1. A method for touchless payment processing, comprising:
transmitting, to a client, a message comprising a link to an interface configured to accept payment information from the client, wherein the message is transmitted in response to the client contacting a vendor with an order for one or more goods or services from the vendor;
receiving, from the client via the interface, the payment information;
processing, using the payment information, a payment corresponding to the order for the one or more goods or services;
transmitting, subsequent to a completion of the processing of the payment, a confirmation of the payment to the client and the vendor; and
transmitting the confirmation of the payment to a delivery person or service provider associated with delivering or performing the one or more goods or services, respectively, wherein:
the one or more goods or services are provided to the client subsequent to the transmitting the confirmation;
an operator of a vendor device is provided with a first authorization level and the delivery person or service provider is provided with a second authorization level, an authorization level being indicative of an amount of data that can be accessed by a person with the authorization level; and
the first authorization level provides the operator access to more than the second authorization level provides to the delivery person or service provider.

2. The method of claim 1, wherein ordering the one or more goods or services corresponds to a first one-time transaction between the client and the vendor.

3. (canceled) 4. (Cancelled)

5. The method of claim 1, wherein the interface is configured to enable the client to input at least one of a gratuity amount, a convenience fee, delivery information, or an expiration time associated with the order.

6. The method of claim 1, further comprising:
identifying, prior to transmitting the message, the client based on a client identifier.

7. The method of claim 6, wherein the client identifier comprises one or more of a phone number associated with a client device of the client, an Internet Protocol (IP) address or a media access control (MAC) address associated with the client device, or an email address of the client.

8. The method of claim 1, wherein processing the payment comprises:
transmitting, to a third-party payment processor, the payment information and details associated with the order for the one or more goods or services; and
receiving, from the third-party payment processor, the confirmation of the payment.

9. The method of claim 8, wherein communication with the third-party payment processor is performed using an application programming interface (API) and an encryption method.

10. The method of claim 1, wherein the message is a short message service (SMS) message or a text message.

11. (canceled)

12. (canceled)

12. (canceled)

13. (canceled)

14. A non-transitory computer-readable medium having code stored thereupon, the code, when executed, causing a processor to implement a method, comprising:
transmitting, to a client, a message comprising a link to an interface configured to accept payment information from the client, wherein the message is transmitted in response to the client contacting a vendor with an order for one or more goods or services from the vendor;
receiving, from the client via the interface, the payment information;
processing, using the payment information, a payment corresponding to the order for the one or more goods or services;
transmitting, subsequent to a completion of the processing of the payment, a confirmation of the payment to the client and the vendor; and
transmitting the confirmation of the payment to a delivery person or service provider associated with delivering or performing the one or more goods or services, respectively, wherein:
the one or more goods or services are provided to the client subsequent to the transmitting the confirmation;
an operator of a vendor device is provided with a first authorization level and the delivery person or service provider is provided with a second authorization level, an authorization level being indicative of an amount of data that can be accessed by a person with the authorization level; and
the first authorization level provides the operator access to more than the second authorization level provides to the delivery person or service provider.

15. A method for touchless payment processing, comprising:
transmitting, to a client, a message comprising a link to an interface configured to accept payment information from the client, wherein the message is transmitted in response to the client contacting a vendor with an order for one or more goods or services from the vendor;
receiving, from the client via the interface, the payment information;
processing, using the payment information, a payment corresponding to the order for the one or more goods or services;
transmitting, subsequent to a completion of the processing of the payment, a confirmation of the payment to the client and the vendor;
transmitting, to the vendor, onboarding information; and
receiving, from the vendor in response to transmitting the onboarding information, information associated with one or more employees of the vendor and the one or more goods or services.

16. A non-transitory computer-readable medium having code stored thereupon, the code, when executed, causing a processor to implement a method, comprising:
transmitting, to a client, a message comprising a link to an interface configured to accept payment information from the client, wherein the message is transmitted in response to the client contacting a vendor with an order for one or more goods or services from the vendor;
receiving, from the client via the interface, the payment information;
processing, using the payment information, a payment corresponding to the order for the one or more goods or services;
transmitting, subsequent to a completion of the processing of the payment, a confirmation of the payment to the client and the vendor;
transmitting, to the vendor, onboarding information; and
receiving, from the vendor in response to transmitting the onboarding information, information associated with one or more employees of the vendor and the one or more goods or services.

17. The method of claim 1, wherein the interface is configured to enable the client to input at least one selected amount in addition to the payment corresponding to the order for the one or more goods or services.

18. The method of claim 17, wherein the at least one selected amount is a tip amount, a charitable contribution, or a support payment for use by the vendor.
